(19) United States
(12) Patent Application Publication
(10) Pub. No.: US 2017/0029739 A1
(43) Pub. Date: Feb. 2, 2017

(54) LOW VISCOSITY BIO-OILS AS SUBSTRATES FOR BPF ADHESIVES WITH LOW FREE FORMALDEHYDE EMISSION LEVELS, THEIR METHODS OF PREPARATION AND USE

(71) Applicant: Ace Econergy Inc., Toronto (CA)

(72) Inventors: Haiyong Chen, Toronto (CA); Chunbao Xu, London (CA); Shanghuan Feng, London (CA); Yan Wang, Toronto (CA)

(73) Assignee: Ace Econergy Inc., Toronto (CA)

(21) Appl. No.: 15/221,639

(22) Filed: Jul. 28, 2016

Related U.S. Application Data
(60) Provisional application No. 62/198,747, filed on Jul. 30, 2015.

(51) Int. Cl. C11B 1/12; C09J 161/06; C11B 3/00; C09J 191/00

(52) U.S. Cl. CPC C11B 1/12; C09J 191/00; C09J 161/06; C11B 3/008

(57) ABSTRACT

The present application is directed to the preparation of low viscosity bio-oils from the hydrothermal liquefaction (HTL) of lignocellulosic biomass in the presence of a crude glycerol and water mixture achieving a high biomass conversion ratio. The modified HTL process allows the direct use of crude glycerol as an effective solvent for biomass liquefaction creating a highly efficient and cost-effective process. Furthermore, the resulting bio-oils containing liquefied biomass, crude glycerol and water, were successfully applied as an inexpensive green substitute in the preparation of bio-based phenol formaldehyde (BPF) adhesives which retain bonding strengths (dry or wet strength) as required by ASTM standard and free formaldehyde emission levels at the F*** and F**** level according to the JIS standard.

### CROSS-REFERENCE TO RELATED APPLICATIONS

The present application claims the benefit of priority from co-pending U.S. provisional application No. 62/198,747 filed on Jul. 30, 2015, the contents of which are incorporated herein by reference in their entirety.

### FIELD

The present application relates to bio-oils useful in BPF adhesives. In particular, the present application relates to low viscosity bio-oils and BPF adhesives with low free formaldehyde emission levels, methods of their preparation and uses thereof.

### BACKGROUND

Phenol formaldehyde (PF) resoles are the base catalyzed poly-condensation products of phenol and formaldehyde. Cured PF resoles are solid, insoluble, rigid materials of high strength and fire resistance, comprising long-term thermal and mechanical stabilities with excellent insulating properties. PF resoles have been extensively used as adhesives for coating and bonding plywood and constructing wood particleboards (oriented strand board (OSB)). However, two issues have been identified within the PF adhesive industry. First, the high cost of phenol leading to the associated high cost of PF resole production; and second, the free formaldehyde emissions generated from PF adhesive products. Formaldehyde has been classified as “carcinogenic to humans” by the International Agency for Research on Cancer (IARC) of the World Health Organization (WHO) [1]. The acceptable levels of free formaldehyde emission from wooden panels have been continuously reduced over the past decades, as a result of increased public awareness, consumer demand for non-hazardous products, as well as environmental regulations.

Crude glycerol is produced in large amounts as a byproduct or waste stream from biodiesel production via transesterification reactions. Biodiesel production generates approximately 1 tonne of crude glycerol per every 10 tonnes of bio-diesel. This has resulted in a decrease in the price for crude glycerol [2]. Large scale producers are able to refine this waste stream for industrial applications whereas small scale producers are unable to justify refining costs and instead pay a fee for crude glycerol removal. It was predicted that by 2020 the global production of crude glycerol will be 41.9 billion litres [3], which will further lower the price of crude glycerol once it enters the market.

Phenol serves as the main raw material for PF adhesive production and is produced in an industrial scale through cumene hydroperoxide from non-renewable petroleum resources. Over the past years, a range of efforts have been committed to explore phenol substitutes from renewable resources [4]. These efforts have led to the production of phenol substitutes through two main routes. One route comprises the direct use of natural aromatic chemicals, for example extractives or lignin directly from lignocellulosic biomass, as a phenol substitute for PF adhesive synthesis; while the other makes use of various thermochemical processes such as phenolation, liquefaction or pyrolysis to convert lignocellulosic biomass into liquid products as phenol alternatives.

Lignocellulosic biomass is composed of lignin and extractives such as tannin (a phenolic compound) which can be used as a phenol substitute for PF adhesive synthesis. Alkaline extraction (i.e., cooking a lignocellulosic biomass in alkaline solution such as NaOH or Na₂CO₃) is used to isolate the aromatic components (extractives) from the biomass and the resulting alkaline extractives are then used directly as a phenol substitute for the synthesis of PF adhesives. The resulting PF adhesives, however, retain high viscosity and shorter shelf-life, which limit their application in industry. Technical lignin, a by-product generated from pulping and cellulosic ethanol plants, served as a promising phenol alternative. Since 1981 in North America, technical lignin based PF adhesives have been utilized in mills for the manufacture of fiberboards, strandboards, and structural plywood [5]. However, due to its large molecular weight and lower reactivity, further modification to technical lignin is needed prior to the production of lignin-based PF adhesives, which limits the application of technical lignin in PF adhesives.

On the other hand, thermochemical routes like phenolation can be used to convert lignocellulosic biomass into liquid products as phenol alternatives. The liquefaction of biomass through phenolation involves a large amount phenol (normally over 3 times that of the biomass by weight) as the liquefaction reagent, and an acid catalyst. The products obtained contain free phenol, combined phenol and phenolated biomass, which are then used collectively as a phenol substitute in PF adhesive synthesis. However, due to the large amount of phenol used in the biomass phenolation process, the produced bio-based PF adhesives have a lower phenol substitution ratio, generally less than 30 wt %.

Hydrothermal liquefaction of lignocellulosic biomass in an ethanol-water mixture has been shown to be a very efficient liquefaction process for converting woody biomass into phenolic bio-crude oils at the temperature range of 200-350° C. [6]. Bio-based phenol formaldehyde (BPF) adhesives produced by sawdust-derived bio-crude oil at 75% phenol substitution, displayed comparable chemical, thermal and curing properties, as well as dry/wet bonding strengths, as the corresponding neat PF adhesives [7]. However, high reactor pressures are generated by the vapour pressure of the ethanol-water solvent mixture. This limits the industrial applications of this process, due to the stringent requirement on the process equipment (in terms of pressure rating) and therefore a higher capital investment.

Pyrolysis is the most common thermochemical process used, and the only industrially realized process, to produce pyrolysis oils that can be utilized as bio-phenols for PF resin synthesis. Oriented strand board (OSB) bonded with bark pyrolysis oil-based PF adhesives, showed excellent modulus of rupture, modulus of elasticity and interior bonding strength, and satisfactory physical thickness swelling [8]. However, the main problem of this technical route is that pyrolysis oils contain a high water content and high concentration of carboxylic acids, resulting in increased acidity and instability. Therefore, further upgrade on the pyrolysis oils are needed before they can be efficiently utilized as a phenol replacement for PF adhesives in industry.

BPF adhesives using bio-phenols generated from the above mentioned thermochemical processes have a common shortcoming. The resulting BPF adhesives contains a high free formaldehyde content, which leads to greater free formaldehyde emission levels when applied to wood products. Although, the free formaldehyde emission levels can be controlled or reduced by the addition of formaldehyde scavengers (e.g., starch, tannin, urea and protein) into the BPF adhesives, the cost of these chemical scavengers are high. Furthermore, the formaldehyde scavengers have to be added in small quantities to ensure the bonding capability of the adhesives are not lost, limiting the industrial application of these modified BPF adhesives.

The use of a hydrothermal liquefaction process in the production of bio-oils from lignocellulosic biomass, a crude glycerin solvent and an acid/base catalyst has been previously disclosed in WO 2012/168407, WO 2015/066507 and U.S. Pat. No. 8,022,257B2, incorporated herein by reference. In particular, U.S. Pat. No. 8,022,257 B2 discloses a method of producing polyols and polyurethanes directly from crude glycerin or through liquefaction of lignocellulosic biomass using crude glycerin as the solvent. The bio-based polyurethane foams are then claimed to have uses for various surfaces including roofs, structural walls, insulated cavities, etc.

The broad concept of a hydrothermal liquefaction process of lignocellulosic biomass using a solvent comprising crude glycerin, an acid/base catalyst under numerous reaction conditions and apparatuses has been reported. However, liquefaction methods amenable to industrial scale applications have not been disclosed, and to the best of Applicant's knowledge, neither have BPF adhesives with low free formaldehyde emission profiles.

Therefore, the development of a novel cost-effective method to produce BPF adhesives with low free formaldehyde emission levels using a green substitute is of great significance.

### SUMMARY

The present application is directed to the preparation of low viscosity bio-oils from the hydrothermal liquefaction (HTL) of lignocellulosic biomass in the presence of a crude glycerol and water mixture achieving a high biomass conversion ratio. The modified HTL process allows the direct use of crude glycerol as an effective solvent for biomass liquefaction creating a highly efficient and cost-effective process. Furthermore, the resulting bio-oils containing liquefied biomass, crude glycerol and water, were successfully applied as an inexpensive green substitute in the preparation of bio-based phenol formaldehyde (BPF) adhesives which retain bonding strengths (dry or wet strength) on wooden panels as required by ASTM standard and free formaldehyde emission levels at the F*** and F**** level according to the JIS standard.

Accordingly, the present application includes a method of producing low viscosity bio-oil from lignocellulosic biomass comprising:
(a) combining the lignocellulosic biomass with a solvent comprising crude glycerol and water in a weight ratio of about 4:1 to about 1:4 in a sealed reactor to provide a reaction mixture;
(b) treating the reaction mixture of (a) under hydrothermal liquefaction (HTL) conditions for conversion of the lignocellulosic biomass into bio-oil;
wherein the HTL conditions comprise a temperature of about 180° C. to about 350° C., a pressure of about 0.1 MPa to about 10 MPa, and a time period of about 0.1 minute to about 300 minutes, optionally in the presence of a catalyst, under an inert or reducing gas atmosphere;
(c) filtering the mixture; and optionally
(d) removing solvents having boiling points less than about 105° C.

In an embodiment, the HTL conditions for conversion of the lignocellulosic biomass into bio-oil comprise a temperature of about 180° C. to 300° C., a pressure of about 3 MPa to about 6 MPa, a time period of 0.1 to about 120 minutes, in the presence of a base catalyst, under an inert or reduce gas atmosphere. In another embodiment, the sealed reactor is optionally pressurized by inert or reducing gases selected from one or more of N₂, He, Ne, Ar and H₂ or combinations thereof. In a further embodiment, the solvent comprises crude glycerol and water in a weight ratio of about 4:1, about 3:1, about 2:1, about 1:1, about 1:2 or about 1:3.

The present application also reports a method of preparing bio-based phenol formaldehyde (BPF) adhesives comprising:
(a) treating the low viscosity bio-oil prepared from the liquefaction of lignocellulosic biomass using a method of the present application, with a PF resole resin under conditions to provide BPF adhesives;
wherein about 1% to about 80% of the bio-oil is combined and stirred with the PF resole resin at room temperature for about 10 minutes to about 30 minutes.

In an embodiment, the method of preparing BPF adhesives further comprises the addition of additives. In another embodiment, the bio-oil comprise about 25% w/w to about 80% w/w, about 40% w/w to about 70% w/w or about 50% w/w of the BPF adhesives.

In an embodiment, the BPF adhesive prepared using a method of the present application has a bonding strength (dry or wet strength) required by the ASTM standard. In another embodiment, the BPF adhesive has free formaldehyde emission levels at the F*** and F**** level in accordance with the JIS standard. In a further embodiment, a wood product is treated with the BPF adhesive of the present application.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### DRAWINGS

The embodiments of the application will now be described in greater detail with reference to the attached drawings in which:

FIG. 1 shows the biomass conversion rates at temperatures of 180° C., 220° C. and 260° C. during sodium hydroxide catalyzed liquefaction of different lignocellulosic biomass feedstocks in a crude glycerol and water (1:1, w/w) mixture under the initial pressure of 1.0 MPa in exemplary embodiments of the application.

FIG. 2 shows the dry/wet tension shear strength results of 3-ply plywoods bonded with BPF adhesives containing 50 wt % of an exemplary bio-oil. The bio-oil was produced from the liquefaction conditions comprising 20 wt % of substrate concentration in a crude glycerol and water (1:1, w/w) mixture at 180° C. for 90 min, 3 MPa reactor pressure, and NaOH catalyst in an exemplary embodiment of the application.

FIG. 3 shows the free formaldehyde emission level from 3-ply plywoods bonded with BPF adhesives containing 50 wt % of an exemplary bio-oil. The bio-oil was produced from the liquefaction conditions comprising 20 wt % substrate concentration in a crude glycerol and water (1:1, w/w) mixture at 180° C. for 90 min, 3 MPa reactor pressure, and NaOH catalyst in an exemplary embodiment of the application.

FIG. 4 shows the structures of the three monomers of lignin.

FIG. 5 shows an exemplary reaction scheme between bio-oil (H unit lignin monomer) and neat PF resole precursors for phenolic adhesive curing.

FIG. 6 shows an exemplary reaction scheme between bio-oil (G unit lignin monomer) and neat PF resole precursors for phenolic adhesive curing.

FIG. 7 shows an exemplary reaction scheme between bio-oil (S unit lignin monomer) and neat PF resole precursors for phenolic adhesive curing.

### DETAILED DESCRIPTION

I. Definitions

Unless otherwise indicated, the definitions and embodiments described in this and other sections are intended to be applicable to all embodiments and aspects of the present application herein described for which they are suitable as would be understood by a person skilled in the art.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this application and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The present description refers to a number of chemical terms and abbreviations used by those skilled in the art. Nevertheless, definitions of selected terms are provided for clarity and consistency.

As used in this application, the singular forms “a”, “an” and “the” include plural references unless the content clearly dictates otherwise. For example, an embodiment including “a solvent” should be understood to present certain aspects with one compound or two or more additional compounds.

In embodiments comprising an “additional” or “second” component, such as an additional or second solvent, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “suitable” as used herein means that the selection of the particular compound or conditions would depend on the specific synthetic manipulation to be performed, and the identity of the molecule(s) to be transformed, but the selection would be well within the skill of a person trained in the art. All process/method steps described herein are to be conducted under conditions sufficient to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

The term “w/w” as used herein means the number of grams of solute in 100 g of solution.

The term “water” as used herein as a component in the liquefaction solvent of the application refers to distilled or deionized water.

The term “lignocellulosic biomass” as used herein refers to any plant-derived organic matter (woody or non-woody) available to produce energy. The lignocellulosic biomass can include, but is not limited to, agricultural crop wastes and residues including corn stover, sugarcane, bagasse, rice stalk, soy bean straw, etc., wood energy crops, wood wastes and residues including saw dust, wood chips, dead trees, etc. and virgin biomass which includes all naturally occurring terrestrial plants, such as trees, bushes and grass and industrial paper pulp. Lignocellulosic biomass primarily consists of natural polymers including hemicellulose, cellulose and lignin.

The term “lignin” as used herein is defined as a random network of polymers with a variety of linkages, based on phenyl propane units. The polyphenolic compounds contain three main phenyl-propanols, termed monolignols, i.e., guaiacyl-propanol (G), syringyl-propanol (S), and p-hydroxyl-phenyl-propanol (H).

The term “crude glycerol” or “glycerol” are used interchangeably and refer to the compound 1,2,3-propanetriol. Crude glycerol comprises glycerol, methanol, inorganic salts, water, oils, soap, etc., wherein the glycerol content is about 20-80% and the product is, for example, obtained as a by-product of a reaction for producing biodiesel fuel.

The term “hydrothermal liquefaction” are used herein refers to the thermochemical conversion of biomass into bio-oils by processing lignocellulosic biomass in a hot, pressurized water environment for sufficient time to break down the biopolymeric structure of lignin, cellulose and hemicllulose to mainly liquid components.

The term “bio-oil” as used herein refers to a complex mixture of chemical species that result from the liquefaction of lignocellulosic biomass which results in the decomposition of cellulose, fatty acids, triglycerides, hemicelluloses, and lignin. There are a number of compounds identified within the bio-oil, some of which include, but are not limited to, hydroxyaldehydes, hydroxyketones, sugars, carboxylic acids and phenolics.

The term “low viscosity bio-oil” as used herein refers to bio-oil having a viscosity ranging from about 10 cP to about 100 cP at 50° C. The viscosity of the bio-oils was tested and measured using a CAP 2000+ viscometer at 50° C.

The term “resin” as used herein is used to describe both natural and synthetic glues which derive their adhesive properties from their inherent ability to polymerize in a consistent and predictable fashion.

The term “phenol-formaldehyde resin” as used herein refers to a phenol formaldehyde of the resole type wherein the compositions comprise a molar ratio of phenol and formaldehyde from 1.1-3.0. Such resins include but are not limited to phenol formaldehyde (PF), phenolic melamine urea formaldehyde (PMUF), and phenol urea formaldehyde (PUF) resins.

The term “evaporation” as used herein refers to the removal or vaporization of a solvent by increasing the temperature and/or decreasing the pressure of the system comprising the solvent.

The term “biomass conversion” as used herein refers to the weighted calculated ratio of the solid residue weight obtained after the liquefaction process divided by the air-dried biomass weight. The ratio is expressed as the following equation:

$$Biomass Conversion = ( 1 - \frac{Solid residue weight}{Air dried biomass weight \times ( 100 - MC )} ) \times 100 \%$$

The term “ASTM standard” as used herein refers to standards previously established for testing adhesives. Adhesives have different properties depending on their volatile and non-volatile contents, thus standards help to identify these properties which include viscosity, adhesion, shear strength, and shear modulus. The standards also help to identify adhesive bond or joint mechanical properties which include strength, creep, fracture and fatigue. The present application uses the ASTM D 906-98 (2011) test, which measures for shear strength. The test method covers the determination of the comparative shear strengths of adhesives in plywood-type construction, when tested on a standard specimen under conditions of preparation, conditioning and testing.

The term “JIS standard” as used herein refers generally to the Japanese Industrial Standards, which are established standards used for industrial activities in Japan. The present application, specifically, uses the JIS standard A 1460, a desiccator method to test for the quantity of formaldehyde emitted from building boards. This method uses a glass desiccator in which the emitted quantity of formaldehyde is obtained and measured from the concentration of formaldehyde absorbed in distilled water or deionized water when the test pieces of a specified surface area are placed in the desiccator filled with a specified amount of distilled or deionized water and left for 24 hours.

II. Method of the Application to Produce Bio-Oil

The present application is directed to the preparation of low viscosity bio-oils from the liquefaction of lignocellulosic biomass in the presence of a crude glycerol and water mixture achieving a high biomass conversion ratio. The modified HTL process allows the direct use of crude glycerol as an effective solvent for biomass liquefaction creating a highly efficient and cost-effective process. Furthermore, the resulting bio-oils containing liquefied biomass, crude glycerol and water, were successfully applied as an inexpensive green substitute in the preparation of bio-based phenol formaldehyde (BPF) adhesives which retain bonding strengths (dry or wet strength) on wooden panels as required by ASTM standard and free formaldehyde emission levels at the F*** and F**** level according to the JIS standard.

Accordingly, the present application reports a method of producing low viscosity bio-oil from lignocellulosic biomass comprising:
(a) combining the lignocellulosic biomass with a solvent comprising crude glycerol and water in a weight ratio of about 4:1 to about 1:4 in a sealed reactor to provide a reaction mixture;
(b) treating the reaction mixture of (a) under hydrothermal liquefaction (HTL) conditions for conversion of the lignocellulosic biomass into bio-oil;
wherein the HTL conditions comprise a temperature of about 180° C. to about 350° C.,
a pressure of about 0.1 MPa to about 10 MPa, and a time period of 0.1 to about 300 minutes, optionally in the presence of a catalyst, under an inert or reduced gas atmosphere;
(c) filtering the mixture; and optionally
(d) removing solvents having boiling points less than about 105° C.

In an embodiment, the HTL conditions for conversion of the lignocellulosic biomass into bio-oil comprise a temperature of about 180° C. to about 300° C., a pressure of about 3 MPa to about 6 MPa, a time period of 0.1 to about 120 minutes, in the presence of a base catalyst, under an inert or reduced gas atmosphere. In another embodiment, the liquefaction process is held for a time period of 90 minutes. In another embodiment, the base catalyst is selected from one or more of NaOH, KOH, Na₂CO₃ and K₂CO₃. In yet another embodiment, the base catalyst is NaOH. In a further embodiment, the sealed reactor is optionally pressurized by inert or reduced gases selected from one or more of N₂, He, Ne, Ar, and H₂ or combinations thereof. In yet a further embodiment, the inert gas is N₂.

In an embodiment, the crude glycerol is a by-product of bio-diesel production. In another embodiment, the crude glycerol has a purity in the range of about 10% to about 90%. In a further embodiment, the crude glycerol has a purity in the range of about 20% to about 80%.

In an embodiment, the solvent of the HTL process comprises crude glycerol and water in a weight ratio of about 4:1. In another embodiment, the solvent of the HTL process comprises crude glycerol and water in a weight ratio of 3:1. In yet another embodiment, the solvent of the HTL process comprises crude glycerol and water in a weight ratio of about 2:1. In a further embodiment, the solvent of the HTL process comprises crude glycerol and water in a weight ratio of about 1:1. In yet a further embodiment, the solvent of the HTL process comprises crude glycerol and water in a weight ratio of 1:2. In yet a further embodiment, the solvent of the HTL process comprises crude glycerol and water in a weight ratio of 1:3.

In an embodiment, the lignocellulosic biomass is obtained from a plant material selected from one or more of bamboo, spruce bark, wood, corn stalk, wheat stalk, straw, sugarcane, grass, waste papers and any other lignocellulosic biomass comprising lignin, cellulose, and hemicellulose. In another embodiment, the lignocellulosic biomass is corn stalk, spruce bark, or bamboo or combinations thereof.

In an embodiment, the biomass is converted to bio-oil in a percent conversion of about 10% to about 90%. In another embodiment, the biomass is converted to bio-oil in a percent conversion of about 20% to about 80%. In a yet another embodiment, the biomass is converted to bio-oil in a percent conversion of about 30% to about 70%. In a further embodiment, the biomass is converted to bio-oil in a percent conversion of about 40% to about 60%.

In an embodiment, the bio-oil produced from the liquefaction of lignocellulosic biomass comprises unreacted lignocellulosic biomass, crude glycerol and water.

In an embodiment, the solvents having boiling points less than about 105° C. are removed by evaporation. In another embodiment, the solvents having boiling points less than about 105° C. are selected from methanol, acetone or 1,4-dioxane or combinations thereof. In a further embodiment, the solvent having a boiling point less than about 105° C. is methanol.

In an embodiment, the bio-oil has a low viscosity in the range of about 10 cP to about 100 cP.

III. Method of the Application to Produce Bio-Based Phenol Formaldehyde (BPF) Adhesives

The present application also includes a method of preparing bio-based phenol formaldehyde (BPF) adhesives comprising:
(a) treating the low viscosity bio-oil prepared from the liquefaction of lignocellulosic biomass using a method of the present application, with a PF resole resin under conditions to provide BPF adhesives;
wherein about 1% to about 80% of the bio-oil is combined and stirred with the PF resole resin at room temperature for about 10 minutes to about 30 minutes.

In an embodiment, the PF resole resin is neat PF resole resin. In another embodiment, the neat PF resole resin comprises a formaldehyde to phenol molar ratio of 1.1 to 3.0. In yet another embodiment, the neat PF resole resin comprises a formaldehyde to phenol molar ratio of 1.8.

In an embodiment, the method of preparing BPF adhesives further comprises the addition of additives. In another embodiment, the additives are selected from one or more of tannin, isocyanate, wheat flour, paraformaldehyde and hexamethylenetetramine.

In an embodiment, the bio-oil is combined and stirred with the PF resole resin at room temperature for about 20 minutes.

In an embodiment, the bio-oil comprises about 25% w/w to about 80% w/w of the BPF adhesives. In another embodiment, the bio-oil comprises about 40% w/w to about 70% w/w of the BPF adhesives. In a further embodiment, the bio-oil comprises about 50% w/w of the BPF adhesives.

In an embodiment, the BPF adhesives have a bonding strength (dry or wet strength) required by the ASTM standard. In another embodiment, the BPF adhesives have free formaldehyde emission levels at F*** and F**** level in accordance with the JIS standard.

IV. BPF Adhesives of the Application

In the present application, a BPF adhesive is prepared from the methods of the present application.

In an embodiment, a wood product is treated with the BPF adhesive prepared from the methods of this present application. In another embodiment, the wood product is selected from 3-ply plywood, fiberboards and strandboards.

### EXAMPLES

The following non-limiting examples are illustrative of the present application:

### Example 1

### Hydrothermal Liquefaction of Lignocellulosic Biomass to Prepare Bio-Oil

I. Materials and Methods

Three types of lignocellulosic biomass (corn stalk, spruce bark, and bamboo) were tested as representative biomass feedstocks for bio-oil production. Before the liquefaction operation, all the feedstocks were air-dried for 15 days. Furthermore, the moisture contents (MC) of the air dried feedstock biomass were determined through oven-drying at 105° C. for 24 hours.

The liquefaction solvent comprised of crude glycerol obtained from a local bio-diesel company (˜30% purity) is used as received. Furthermore, an alkaline catalyst (sodium hydroxide) was investigated for the liquefaction process.

In a typical liquefaction process, lignocellulosic biomass feedstock, a base catalyst and a liquefaction solvent comprising crude glycerol and water in a 1:1 w/w mixture were fed into a reactor. The reactor was then pressurized using N₂, and heated to a specific temperature point and held at that temperature for a period of time, for example 90 min.

After the reaction is complete, the reactor is cooled to room temperature, the gas in the reactor (mainly containing N₂) is vented prior to being opened. The slurry in the reactor was transferred into a container, and the reactor was flushed or rinsed with methanol. The admixture of the slurry and rinsing methanol were then filtered. The precipitate was washed with methanol until the filtrate became colorless. After filtration, the solid residue was oven dried at 105° C. for 24 hours, then weighed to calculate the biomass conversion in the following Eq. (1):

$$Biomass Conversion = ( 1 - \frac{Solid residue weight}{Air dried biomass weight \times ( 100 - MC )} ) \times 100 \% \qquad Eq . ( 1 )$$

where MC is the moisture content (wt %) of the air dried biomass.

Methanol in the filtrate was concentrated under reduced pressure at 45° C. The resulting black liquid comprising liquefied lignocellulosic biomass, crude glycerol and water was designated as the bio-oil product.

### Example 2

### Preparation of a Neat PF Adhesive

As a reference, a neat PF adhesive was synthesized at a formaldehyde to phenol molar ratio of 1.8:

100 g phenol, 40 g water and 30 g 50% NaOH solution were charged into a 500 mL three-neck glass reactor connected to a refluxing condenser, wherein the reactor was equipped with magnetic stirring and was heated. During the heating process, 155.25 g of 37% formalin was fed into the reactor drop-wise. The reactor was first heated to 65° C. and held at 65° C. for 120 min, then further heated to 84° C. and held at 84° C. for 60 min. The reaction mixture was subsequently quenched with the addition of ice water.

### Example 3

### Preparation of BPF Adhesives

The bio-oils obtained from the sodium hydroxide catalyzed liquefaction of bamboo, bark and corn stalk as described in Example 1 were used as a constitute in a conventional PF resole resin to formulate BPF adhesives containing up to 50-75 wt % of bio-oil.

To formulate BPF adhesives, a bio-oil at a specific weight ratio was blended with a conventional PF adhesive of Example 2 at room temperature and stirred for 20 min. The formulated PF adhesives were designated as BPF adhesives.

### Example 4

### Tension Shear Strength of 3-Ply Plywood Bonded with Various BPF Adhesives

3-ply plywood was prepared using the BPF adhesives containing 50% w/w of bio-oil derived from various lignocellulosic biomass feedstocks obtained from Example 1 to characterize the bonding capabilities of the BPF adhesives. Furthermore, the neat PF adhesive is used as a comparative reference for their bonding strength properties with the BPF adhesives.

Commercial white birch veneers (12 inch×12 inch× 1/16 inch) were used as the substrate materials. Before use, the veneers were conditioned at 20° C. and 65% relative humidity in an environmental chamber for 7 days.

The BPF adhesive was spread on the surface of the veneers substrate at a rate of 200 g/m². After 60 min assembly time, the veneers were pressed at 140° C. under 3.0 MPa for 4 min to laminate a 3-ply plywood panel.

Mechanical test specimens were prepared by cutting the bonded plywood panel in accordance to ASTM D 906-98 (ASTM, Reapproved 2011). The specimens were tested for shear stress by tension loaded with a bench-top universal testing machine (ADMET eXpert 7600 Series Universal Materials Testing Machine) at a loading rate of 3 mm/min until failure.

Half of the plywood specimens were tested at room temperature after being conditioned at 20° C. and 65% relative humidity in an environmental chamber for 7 days and used for the dry tension shear strength test. Whereas, the other half were tested for wet tension shear strength, which was conducted after the specimens were boiled in water for 3 hours.

### Example 5

### Free Formaldehyde Emission Levels from 3-Ply Plywood Bonded with Various BPF Adhesives

Free formaldehyde emission levels from the BPF adhesives bonded plywoods were determined in accordance with the method of JIS A 1460 Standard (JIS, 2001).

The plywood specimens were cut with a surface dimension of 150 mm×50 mm. Prior to the tests, the plywood specimens were conditioned at 20° C. and 65% relative humidity for 7 days. In each test run, ten conditioned plywood specimens were placed in a 10 L glass desiccator for 24 hours. Any free formaldehyde released from the test specimens during the 24 hour period is absorbed by the distilled water (300 ml) in a petri dish. The amount of the absorbed formaldehyde was then determined photometrically at 412 nm on a UV spectrophotometer (Evolution 220, Thermal Scientific).

### Example 6

### Stability of the BPF Adhesives

Viscosities of the bio-oil derived from cornstalk in Example 1, and BPF adhesives containing 50% w/w of bio-oil derived from cornstalk obtained from Example 1 were tested over 40 days to determine the shelf life. Furthermore, the neat PF adhesive is used as a comparative reference for the viscosity tests.

The tested samples were left in 100 mL vials at room temperature, and viscosities were tested by a CAP 2000+ viscometer from Brookfield, with N44, N 140, N250 and N415 from Cannon Instrument Company USA as viscosity standards at 50° C. for the calibration.

II. Results and Discussion

The present application reports the preparation of low viscosity bio-oils from the liquefaction of lignocellulosic biomass in the presence of a 1:1 crude glycerol and water mixture operating under comparatively mild conditions (lower temperature and pressure) achieving a high biomass conversion ratio. The modified HTL process allows the direct use of crude glycerol as an effective solvent for biomass liquefaction, creating a highly efficient and cost-effective process. The resulting bio-oils were successfully applied as an inexpensive green substitute in the preparation of BPF adhesives. The application of the BPF adhesives to engineered wood products exhibit satisfactory bonding strengths (dry or wet strength) meeting the requirements of the ASTM standard. More importantly, the BPF adhesives contribute to a greatly reduced free formaldehyde emission level from the bonded plywood samples as determined by the JIS standard.

Previously, HTL processes were carried out using an ethanol-water mixture as the liquefaction solvent. Unfortunately, high reactor pressures (>10-15 MPa) are generated by the vapour pressure of the ethanol-water mixture, placing a stringent requirement on the process equipment (in terms of pressure rating) to accommodate such high pressures. This can decrease the feasibility of industrial applications and lead to soaring capital investments. In addition, most direct liquefaction has been carried out using crude glycerol, however, the resulting bio-oil has highly viscous characteristics. Therefore, several parameters including temperature, liquefaction solvent and the reaction apparatus were explored to derive an HTL process which would be amenable to industrial applications and provide high biomass conversions.

Firstly, to decrease the viscosity of the resultant bio-oil, the crude glycerol liquefaction solvent was initially diluted with water at a 1:1 w/w ratio and introduced into a sealed reactor with the lignocellulosic biomass. Considering the increased moisture content, a sealed reaction apparatus was used to allow the reaction system to reach liquefaction temperatures at a faster rate.

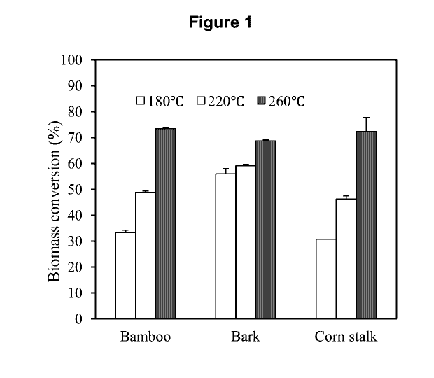

Utilizing the new liquefaction solvent and reaction apparatus parameters, optimal temperature ranges of the HTL process were explored as a means to achieve higher biomass conversions. Three types of lignocellulosic biomass feedstocks were tested including bamboo, spruce bark and corn stalk. The liquefaction of each biomass was conducted under the catalysis of sodium hydroxide (10% feedstock) with a biomass/crude glycerol/water ratio of 1:3:3 (w/w/w) for 90 min under N₂ atomsphere of 1.0 MPa in a sealed reactor at temperatures of 180° C., 220° C. and 260° C. As FIG. 1 illustrates, at 180° C., the conversion of bamboo, spruce bark and corn stalk were measured at 33.3%, 56.0% and 30.7%, respectively. At 220° C., the conversion increased to 48.9%, 59.2% and 46.2%, respectively. The liquefaction temperature was further increased to 260° C., in which the biomass conversion greatly increased to 73.5%, 68.9% and 72.4%, for bamboo, spruce bark and corn stalk respectively. The temperature trends imply that as the temperature increases, specifically to 260° C., a greater biomass conversion of the lignocellulosic biomass to bio-oil is observed. In particular, increasing temperatures exerts a greater effect on the conversion of bamboo and corn stalk, in comparison to spruce bark.

One of the objectives of the present application is to achieve higher biomass conversions under mild liquefaction conditions, in particular, conditions which amount to lower pressure in the sealed reactor. The optimal conditions that were obtained for the liquefaction of lignocellulosic biomass involved the use of a 1:1 crude glycerol and water mixture at temperatures in the range of about 180° C. to about 350° C., for about 0 to about 300 minutes with a basic catalyst, under low pressures of about 1 MPa to about 6 MPa. Without wishing to be bound by theory, both the liquefaction solvent and reaction apparatus are thought to afford the low pressure within the reaction apparatus. In particular, the excess addition of water with crude glycerol in a sealed reactor allows the system to reach liquefaction temperatures at a quicker rate, therefore maintaining low pressures (4-7 MPa), and providing a cost-effective method amenable for industrial applications.

The liquefaction conditions of the present application were compared to a similar HTL process disclosed in the U.S. Pat. No. 8,022,257 B2 (“Li et. al”). Li et. al teaches the liquefaction of lignocellulosic biomass using crude glycerol as the liquefaction solvent in an ‘open’ reflux system. A comparative study was conducted between Li et. al's HTL conditions and the HTL conditions of the present application, wherein the liquefaction solvent (1:1 crude glycerol and water) of the present application was tested in an ‘open’ system, and the liquefaction solvent (crude glycerol) of Li et. al was tested within a sealed reactor system. As Table 1. illustrates, the use of a sealed reactor with 1:1 crude glycerol and water mixture contributed to higher biomass conversion rates in comparison to those obtained using Li et. al's HTL conditions.

The bio-oils obtained from the sodium hydroxide catalyzed liquefaction of bamboo, bark and corn stalk as described in Example 1 were used as a constitute in a neat PF resole resin to formulate BPF adhesives comprising up to 50-75 wt % of bio-oil.

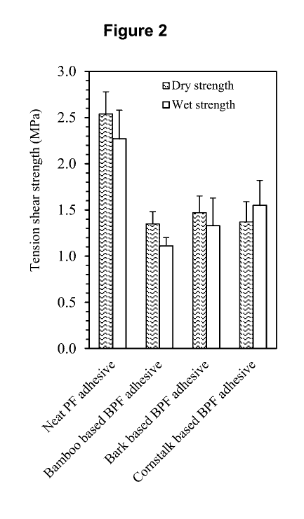

3-ply plywood was prepared using the BPF adhesives containing 50 wt % bio-oil derived from various biomass feedstocks obtained from Example 2, to characterize the bonding capability of the BPF adhesives. As illustrated in FIG. 2, the 3-ply plywood bonded with a neat PF adhesive displays tension shear strengths of 2.54 MPa and 2.27 MPa at dry and wet conditions, respectively. The plywood specimens bonded with all the BPF adhesives of the present application exhibit excellent dry and wet tension shear strengths, satisfying the requirements by the ASTM standard under dry and wet conditions. The plywood bonded with BPF adhesive containing bamboo bio-oil exhibits the poorest performance among all three bio-oils, having dry and wet tension shear strength of 1.35 MPa and 1.11 MPa, respectively. The BPF adhesive derived from spruce bark bio-oil provides dry and wet tension shear strength of 1.47 MPa and 1.33 MPa MPa, respectively. The plywood specimen bonded with the BPF adhesive derived from cornstalk bio-oil, provided the highest dry and wet tension shear strength of 1.55 MPa and 1.37 MPa, respectively.

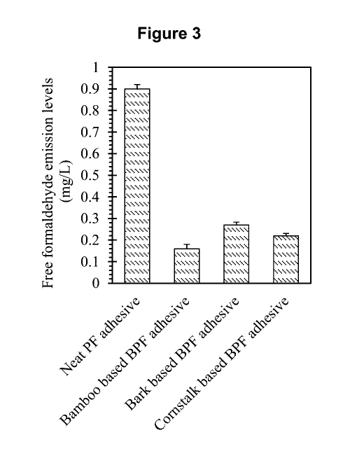

Free formaldehyde emission levels from the BPF adhesives bonded plywoods were determined in accordance with the method of JIS A 1460 Standard (JIS, 2001). FIG. 3 illustrates the free formaldehyde emission levels from the plywood specimens bonded by BPF adhesives containing 50 wt % bio-oil from the sodium hydroxide catalyzed liquefaction of bamboo, bark and cornstalk. The free formaldehyde emission levels are extremely low, reporting 0.16 mg/L for bamboo, 0.27 mg/L for bark and 0.22 mg/L for cornstalk, which are far below the F**** level of the JIS standard. Furthermore, the free formaldehyde levels for the BPF adhesives generated from the present application are far lower in comparison to the measured free formaldehyde level of neat PF adhesives (0.90 mg/L).

Viscosities of the neat PF adhesive, bio-oil from cornstalk liquefaction and cornstalk bio-oil based BPF adhesive were tested using a CAP 2000+ viscometer from Brookfield at 50° C. As displayed in Table 2, viscosity of neat PF increases from 45.0 cP to 229.5 cP over 40 days, while the viscosity of the bio-oil increase slowly from 22.1 cP to 24.1 cP. For the cornstalk based BPF adhesive, the viscosity increases gradually from 30.1 cP to 139.2 cP.

Crude glycerol is comprised of large amounts of contaminants such as water, methanol, soap/free fatty acids (FFAs), salts, and unused reactants and is known to have a glycerol content in the range of 15-80%. The three hydroxyl groups in glycerol have the potential to react with the ortho or para positions in PF adhesive precursors during the curing process of a BPF adhesive [9]. In addition, straight-chain unsaturated FFAs present in crude glycerol could also react with the PF resole to contribute to PF adhesive curing [10].

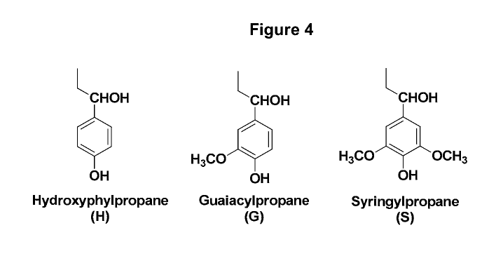

Bio-oils obtained from liquefaction of lignocellulosic biomass are rich in lignin derivatives. Lignin is predominantly composed of three monomers namely the p-hydroxyphenyl-propane units (H), guaiacyl-propane units (G), and syringyl-propane units (S), whose molecular structures are illustrated in FIG. 4. Without wishing to be bound by theory, the lignin derivatives are proposed to undergo several condensation reactions with the neat PF adhesive precursors during the curing process. In particular, the methylols present within the PF adhesive precursors react with the ortho position of lignin derivatives and the C—H bond in the para positions of the neat PF adhesive precursors are thought to react with the α-OH moiety within the propyl side chain of lignin derivatives. These condensation reactions are all thought to contribute to the curing of phenolic adhesives, as illustrated in FIGS. 4-7.

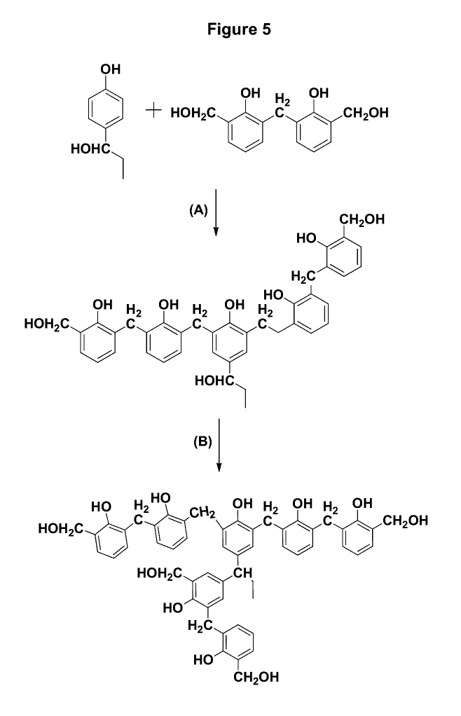

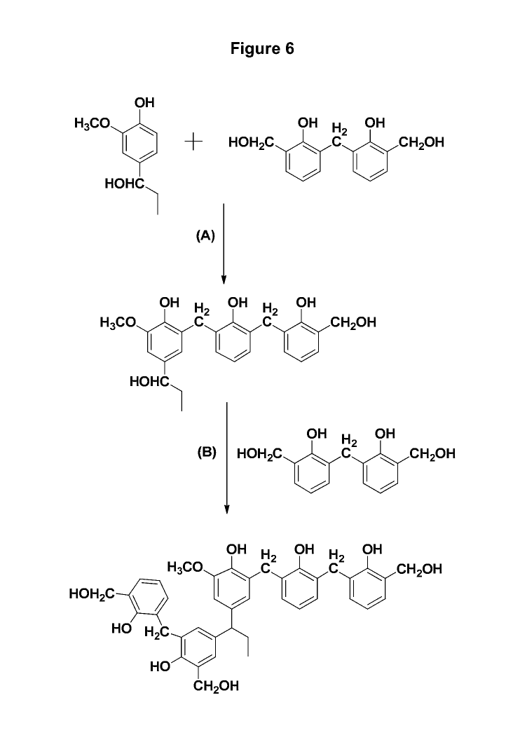

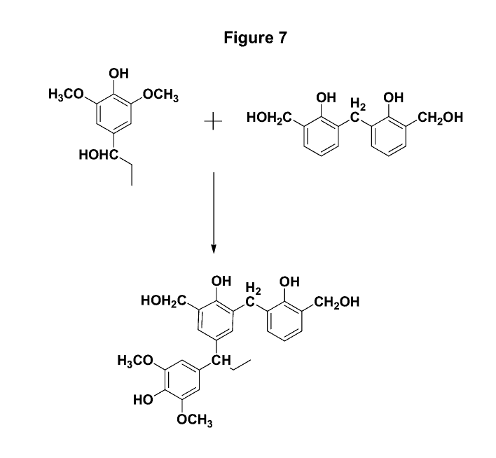

As FIG. 5 illustrates, each hydroxyphenyl-propane (H) structure units have two reactive ortho-hydrogens which can react with the methylols of the PF adhesive precursors. On the other hand, the para-hydrogen of the PF adhesive precursor condenses with the α-OH moiety of the propyl side chains of the H unit, forming an ether linkage. The guaiacyl-propane (G) units have one reactive ortho-hydrogen and one reactive α-OH moiety in its propyl side chain, which can undergo condensation reactions as illustrated in FIG. 6. Whereas, the syringyl-propane (S) units only have the α-OH in the propyl side chain as the reactive site, which undergoes a condensation reaction with the para-hydrogen of a neat PF adhesive, as shown in FIG. 7.

While the present application has been described with reference to examples, it is to be understood that the scope of the claims should not be limited by the embodiments set forth in the examples, but should be given the broadest interpretation consistent with the description as a whole.

TABLE 1

| Liquefaction reagent | Reactor conditions | Conversion (%) |
|---|---|---|
| Crude glycerol | Sealed | 47.1 (3.2) |
| Crude glycerol/water | Sealed | 35.3 (2.10) |
| mixture (50:50, wt/wt) | | |
| Crude glycerol | Relux | 21.7 (1.5) |
| Crude glycerol/water | Relux | 22.5 (2.3) |
| mixture (50:50, wt/wt) | | |

TABLE 2

| | Viscosity at 50° C. (cP) | | | | | | | | | |
|---|---|---|---|---|---|---|---|---|---|---|
| | | | | 12 | 15 | 20 | 25 | 30 | 35 | 40 |
| | 0 days | 3 days | 5 days | days | days | days | days | days | days | days |
| Neat PF | 45.0 | 68.9 | 105.8 | 129.3 | 145.3 | 166.2 | 178.3 | 189.3 | 210.0 | 229.5 |
| adhesive | | | | | | | | | | |
| Cornstalk | 30.1 | 41.6 | 60.3 | 80.2 | 90.3 | 101.2 | 113.3 | 104.2 | 120.1 | 139.2 |
| based BPF | | | | | | | | | | |
| adhesive | | | | | | | | | | |
| Bio-oil | 22.1 | 22.3 | 22.4 | 23.7 | 22.7 | 23.7 | 22.9 | 23.1 | 23.5 | 24.5 |

### FULL CITATIONS FOR DOCUMENTS REFERRED TO IN THE APPLICATION

1. IARC (2006) Monographs Vol 88: Formaldehyde, 2-butoxyethanol and 1-tert-butoxypropan-2-ol. IARC Monographs, Lyon, France.
2. Effendi A, Gerhauser H, Bridgwater A V. Production of renewable phenolic resins by thermochemical conversion of biomass: A review. Renew Sust Energ Rev 2008; 12: 2092-116
3. Sellers, Jr., Terry. Wood adhesive innovations and applications in North America. Forest Products Journal 2001; 51(6): 12-22.
4. Cheng S, Dcruz I, Wang M, Leitch M, Xu C, Highly Efficient Liquefaction of Woody Biomass in Hot-compressed Alcohol-Water Co-solvents. Energy Fuels 2010; 24: 4659-4667.
5. Cheng S N, D'Cruz I, Yuan Z S, Wang M C, Anderson M, Leitch M, Xu C C Use of bio-crude derived from woody biomass to substitute phenol at high-substitution level for the production of bio-based phenolic Resole resins. J Appl Polym Sci 2011; 121: 2743-51.
6. Chang F, Riedl B, Wang X M, Lu X, Amen-Chen C, Roy C. Performance of pyrolysis oil-based wood adhesives in OSB. Forest Prod J 2002; 52 (4): 31-38.
7. Sims B. Clearing the Way for Byproduct Quality. Biodiesel Magazine. Available online at http://www.biodieselmagazine.com/articles/8137/clearing-the-way-for-byproduct-quality. (Accessed online October, 2011).
8. OECD-FAO. Agricultural Outlook 2011-2020. Retrieved on Mar. 9, 2012. Available online at http://www.oecd.org/document/9/0,3746,en_36774715_36775671_454438665_1_1_1_1,00
9. Rogers D G. Phenolic resin product and method of manufacturing a phenolic resin product. US patent 2009/0264569 A1, Oct. 22, 2009.
10. Suzuki Y. Liquid resole-type phenolic resin and wet paper friction material. US patent 2015/0065756 A1, Mar. 5, 2015.
11. Li Y B, Zhou Y G. Methods for producing polyols using crude glycerin. US patent 2011/8022257 B2, Sep. 20, 2011

1. A method of producing low viscosity bio-oil from lignocellulosic biomass comprising:
(a) combining the lignocellulosic biomass with a solvent comprising crude glycerol and water in a weight ratio of about 4:1 to about 1:4 in a sealed reactor to provide a reaction mixture;
(b) treating the reaction mixture of (a) under hydrothermal liquefaction (HTL) conditions for conversion of the lignocellulosic biomass into bio-oil;
wherein the HTL conditions comprise a temperature of about 180° C. to about 350° C., a pressure of about 0.1 MPa to about 10 MPa, and a time period of 0.1 to about 300 minutes, optionally in the presence of a catalyst, under an inert or reducing gas atmosphere;
(c) filtering the mixture; and optionally
(d) removing solvents having boiling points less than about 105° C.

2. The method of claim 1, wherein the HTL conditions for conversion of the lignocellulosic biomass into bio-oil comprise a temperature of about 150° C. to about 300° C., a pressure of about 3 MPa to about 6 MPa, a time period of 0.1 to about 120 minutes, in the presence of a base catalyst, under an inert or reduced gas atmosphere.

3. The method of claim 2, wherein the base catalyst is selected from one or more of NaOH, KOH, Na₂CO₃ and K₂CO₃.

4. The method of claim 1, wherein if the sealed reactor is pressurized, the pressurizing gas is an inert or reducing gas selected from one or more of N₂, He, Ne, Ar, and H₂ or combinations thereof.

5. The method of claim 1, wherein the crude glycerol is a by-product of bio-diesel production.

6. The method of claim 1, wherein the crude glycerol has a purity in the range of about 10% to about 90%, or about 20% to about 80%.

7. The method of claim 1, wherein the solvent comprises crude glycerol and water in a weight ratio of about 4:1, about 3:1, about 2:1, about 1:1, about 1:2 or about 1:3.

8. The method of claim 1, wherein the lignocellulosic biomass is obtained from a plant material selected from one or more of bamboo, spruce bark, wood, corn stalk, wheat stalk, straw, sugarcane, grass, waste papers and any other lignocellulosic biomass comprising lignin, cellulose, and hemicellulose.

9. The method of claim 1, wherein the biomass is converted to bio-oil in a percent conversion of about 10% to about 90% or about 20% to about 80%.

10. The method of claim 1, wherein the bio-oil comprises unreacted lignocellulosic biomass, crude glycerol and water.

11. The method of claim 1, wherein the bio-oil has a viscosity in the range of about 10 cP to about 100 cP.

12. A method of preparing bio-based phenol formaldehyde (BPF) adhesives comprising:
(a) treating the low viscosity bio-oil prepared using a method of claim 1 with a PF resole resin under conditions to provide BPF adhesives;
wherein about 1% to about 80% of the bio-oil is combined and stirred with the PF resole resin at room temperature for about 10 minutes to about 30 minutes.

13. The method of claim 12, wherein the PF resole resin is neat PF resole resin.

14. The method of claim 12 further comprising addition of additives.

15. The method of claim 14, wherein the additives are selected from one or more of tannin, isocyanate, wheat flour, paraformaldehyde and hexamethylenetetramine.

16. The method of claim 12, wherein the bio-oil comprise about 25% w/w to about 80% w/w, about 40% w/w to about 70% w/w or about 50% w/w of BPF adhesives.

17. The method of claim 12, wherein the BPF adhesive has a bonding strength (dry or wet strength) required by the ASTM standard.

18. The method of claims 12, wherein the BPF adhesive has free formaldehyde emission levels at F*** and F**** level in accordance with the JIS standard.

19. A BPF adhesive prepared using the method of claim 12.

20. A wood product treated with the BPF adhesive of claim 19.
